(19) United States
(12) Patent Application Publication
(10) Pub. No.: US 2013/0169885 A1
(43) Pub. Date: Jul. 4, 2013

(54) DISPLAY DEVICE AND TELEVISION RECEIVER

(71) Applicant: Masataka Tsunemi, Gunma (JP)

(72) Inventor: Masataka Tsunemi, Gunma (JP)

(21) Appl. No.: 13/563,232

(22) Filed: Jul. 31, 2012

(30) Foreign Application Priority Data
Dec. 28, 2011 (JP) 2011-288389

(51) Int. Cl. G02B 3/00; H04N 5/66; G02F 1/13357

(52) U.S. Cl. 348/739; 349/57; 359/642; 348/E05.133

(57) ABSTRACT

According to one embodiment, a display device includes: an image display module having a first surface; a lens module configured to face the first surface and to be connected to the image display module by a connector with a gap from the image display module; and a first spacer configured to be disposed between the image display module and the lens module.

### CROSS-REFERENCE TO RELATED APPLICATIONS

This application is based upon and claims the benefit of priority from Japanese Patent Application No. 2011-288389, filed on Dec. 28, 2011, the entire contents of which are incorporated herein by reference.

### FIELD

Embodiments described herein relate generally to display devices and television receivers.

### BACKGROUND

Display devices incorporating lenticular lenses are known as display devices that display stereoscopic view images. These display devices incorporating lenticular lenses allow users to view stereoscopic views without use of, for example, glasses for viewing stereoscopic views.

In general, a display device incorporating a lenticular lens includes a display panel that is laminated with a lens panel including a lenticular lens. There is a predetermined gap between the display panel and the lens panel.

In such a display device, poor accuracy in the gap between the display panel and the lens panel can result in degradation of images, such as stereoscopic view images.

### BRIEF DESCRIPTION OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary front view illustrating an exemplary display device according to a first embodiment;

FIG. 2 is an exemplary cross-sectional view taken along line F2-F2 of FIG. 1;

FIG. 3 is an exemplary perspective view illustrating a part of a lens panel in the first embodiment;

FIG. 4 is an exemplary cross-sectional view illustrating a part of a display device according to a first modified example of the first embodiment;

FIG. 5 is an exemplary cross-sectional view illustrating a part of a display device according to a second modified example of the first embodiment;

FIG. 6 is an exemplary cross-sectional view illustrating a display device according to a second embodiment;

FIG. 7 is an exemplary exploded perspective view illustrating a part of the display device in the second embodiment;

FIG. 8 is an exemplary front view illustrating a display device according to a third embodiment;

FIG. 9 is an exemplary cross-sectional view taken along line F9-F9 of FIG. 8; and

FIG. 10 is an exemplary front view illustrating a television receiver according to a fourth embodiment.

### DETAILED DESCRIPTION

In general, according to one embodiment, a display device comprises: an image display module having a first surface; a lens module configured to face the first surface and to be connected to the image display module by a connector with a gap from the image display module; and a first spacer configured to be disposed between the image display module and the lens module.

Embodiments will be described in detail below with reference to the accompanying drawings. Multiple embodiments to be described hereunder comprise similar elements. Those similar elements will hereunder be similarly designated and descriptions for those elements will be omitted.

### First Embodiment

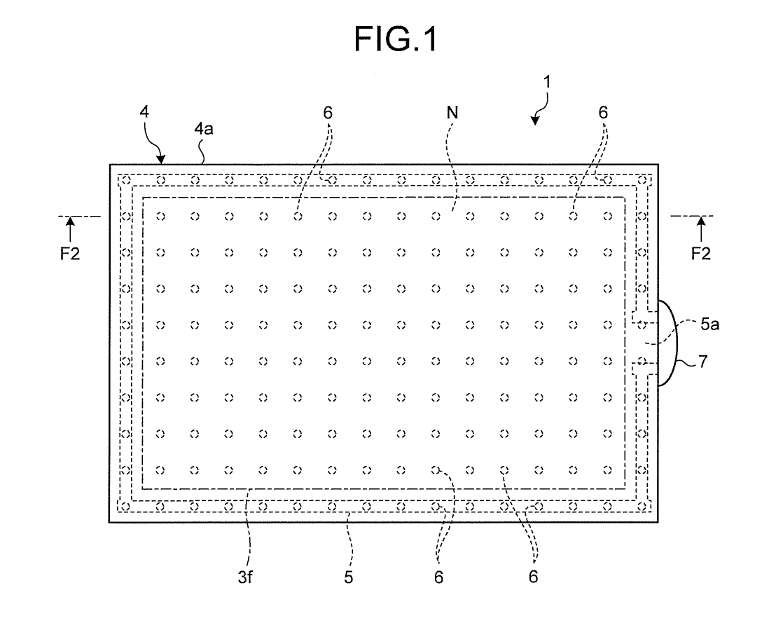

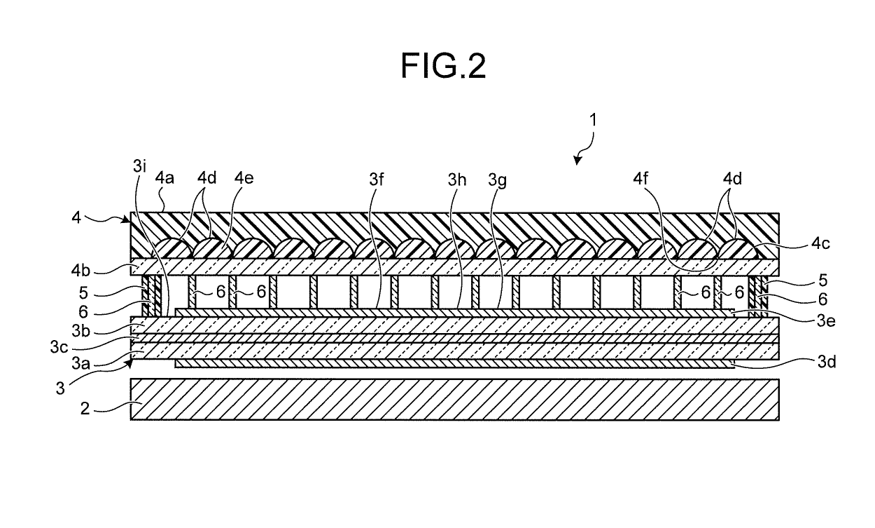

As illustrated in FIG. 1, a display device 1 according to a first embodiment has a substantially rectangular shape in a front view. As illustrated in FIG. 2, the display device 1 comprises a backlight 2, a display panel 3, and a lens panel 4. Specifically, the backlight 2 emits light. The display panel 3 displays an image using the light emitted from the backlight 2. The lens panel 4 comprises a lenticular lens 4c and is bonded (connected) to the display panel 3 via a connector 5. The display panel 3 is an exemplary image display, the lens panel 4 is an exemplary lens, and the connector 5 is an exemplary connector. An internal space N defined by the display panel 3, the connector 5, and the lens panel 4 is hermetically sealed having internal pressure lower than the atmospheric pressure.

The display panel 3 comprises a back substrate (substrate) 3a, such as an array substrate, and a front substrate (substrate) 3b as a front substrate. The display panel 3 is, as an example, a TN liquid crystal panel. A plurality of pixels are arranged in a predetermined pattern, for example, a matrix pattern in a plane of the display panel 3. A liquid crystal layer 3c that constitutes the pixels is disposed between the back substrate 3a and the front substrate 3b. The display panel 3 further comprises a pair of polarizing plates 3d, 3e disposed on outer surfaces of the back substrate 3a and the front substrate 3b, respectively. The polarizing plates 3d, 3e are disposed in mutually opposed positions across the back substrate 3a, the liquid crystal layer 3c, and the front substrate 3b. It is here noted that the display panel 3 has an image display area 3f that substantially coincides, as an example, with an outer surface (an upper surface in FIG. 2) of the polarizing plate 3e. The image display area 3f is an area in the display panel 3 on which an image is displayed (an image display surface). The display panel 3 has a first surface 3g. The first surface 3g is on a side opposite to the side of the backlight 2. An image is displayed on the first surface 3g. The first surface 3g has a front surface (a first surface) 3h of the polarizing plate 3e, and portions other than a portion in a front surface (a first surface) 3i of the front substrate 3b facing the polarizing plate 3e.

The back substrate 3a is, for example, a rectangular glass substrate. The back substrate 3a has an inner surface (the surface facing the front substrate 3b: the upper surface of the back substrate 3a in FIG. 2) on which, for example, a plurality of pixel electrodes and electric wiring for supplying electric potential thereto (neither are illustrated) are disposed. Each of the pixel electrodes is provided in dots for each pixel and the electric wiring is provided in a matrix pattern. The front substrate 3b is, for example, a rectangular glass substrate. The front substrate 3b has an inner surface (the surface facing the back substrate 3a: the lower surface of the front substrate 3b in FIG. 2) on which, for example, a color filter (not illustrated) and an opposed electrode (not illustrated) that serves as a common electrode are disposed. The color filter comprises a plurality of coloring layers (red, green, and blue) disposed in dots or stripes and a light-blocking layer, such as a black matrix.

The lens panel 4 faces the first surface 3g of the display panel 3 and bonded (connected) to the display panel 3 by the connector 5 with a gap interposed from the display panel 3. The gap between the display panel 3 and the lens panel 4 is, as an example, 1 μm to 50 μm, and more preferably, 5 μm to 10 μm.

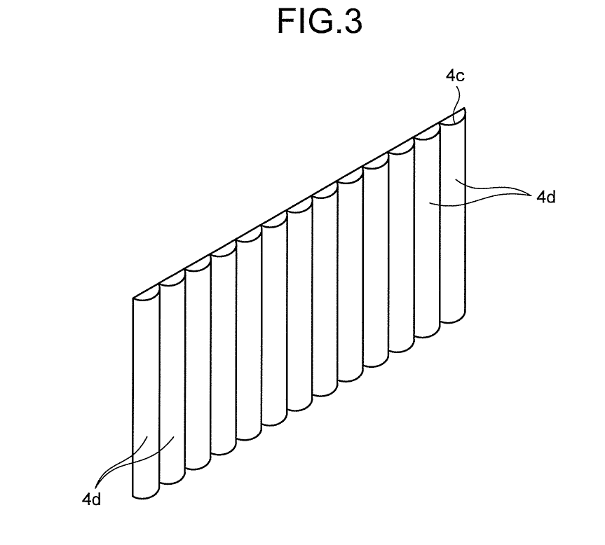

The lens panel 4 comprises a lens substrate 4a and a substrate 4b. The lens substrate 4a comprises the lenticular lens 4c for producing a stereoscopic view image (three-dimensional image). The substrate 4b is disposed on the side of the lens substrate 4a adjacent to the display panel 3. The lens panel 4 is, for example, a rectangular substrate. As illustrated in FIGS. 2 and 3, the lenticular lens 4c is formed of a plurality of cylindrical lenses 4d arrayed adjacent to each other in a direction (a transverse direction) orthogonal to an axial direction (a cylindrical axis direction, a longitudinal direction, specifically, a ridge direction). The cylindrical lens 4d is shaped like a cylinder split into two in an axial direction thereof. It is noted that the cylindrical lenses 4d may be arrayed in a position tilted by about 10 degrees relative to the axial direction, instead of being orthogonally arrayed relative to the axial direction. The cylindrical lenses 4d represent an example of lenses arrayed in parallel with each other. It is here noted that the cylindrical lens 4d is a cylinder-shaped lens having a curvature only in one direction and one curvature surface. The lenticular lens 4c is formed on the surface of the lens panel 4 adjacent to the display panel 3 so as to be recessed in a direction away from the display panel 3. The lenticular lens 4c is filled with a filling 4e. The lens substrate 4a is formed of, as an example, a light-curing resin, such as a UV resin, and the filling 4e is formed of, as an example, a liquid crystal polymer. The substrate 4b is, as an example, a rectangular glass substrate.

As illustrated in FIG. 2, the connector 5 is disposed between a peripheral edge portion of the display panel 3 and a peripheral edge portion of the lens panel 4, connecting the display panel 3 and the lens panel 4 through, for example, bonding. As illustrated in FIG. 1, the connector 5 is disposed outside the image display area 3f of the display panel 3. The connector 5 is formed, for example, into a substantially rectangular frame shape. The connector 5 has an opening 5a that is sealed by a sealing material 7. The connector 5 and the sealing material 7 function as a wall that joins the display panel 3 to the lens panel 4 to thereby define the internal space N and to keep the internal space N airtight. A light-curing resin, for example, is used for the connector 5.

As illustrated in FIGS. 1 and 2, a spacer 6 is disposed between the display panel 3 and the lens panel 4. The spacer 6 is an example of a first spacer. The spacer 6 comprises a plurality of the spacers 6 disposed in a matrix pattern. Each of the spacer 6 is columnar in shape, and is cylindrical, for example. The spacer 6 may alternatively be a polygonal column in shape, such as a triangular prism and a quadrangular prism. The spacer 6 has a first end connected to the display panel 3 and a second end connected to the lens panel 4. A first part of the multiple spacers 6 faces the image display area 3f of the display panel 3. The first part of the spacers 6 is disposed, as an example, at a boundary (boundary line) 4f between adjacent cylindrical lenses 4d, overlapping in the direction in which the display panel 3 and the lens panel 4 overlap each other (in a vertical direction in FIG. 2). A second part of the spacers 6 is disposed at the connector 5. To state it differently, the second part of the spacers 6 is covered in the connector 5. The spacer 6 is, as an example, transparent. Nonetheless, the spacer 6 may not necessarily be transparent and may, for example, be black. The spacer 6, such as those described above, may, for example, be formed of a transparent member, such as glass. The spacer 6 may be formed integrally with, or separately from, the lens panel 4 or the display panel 3. As an example, the spacer 6 may be integrally disposed on the substrate 4b of the lens panel 4 through photolithography. The photolithography is preferable in that the gap between the display panel 3 and the lens panel 4 can be controlled on the order of several tenths of a micrometer. A material used for the spacer 6, and diameter, height, disposition density, and other parameters of the spacer 6 may be appropriately set within an extent that any of those parameters does not seriously affect display characteristics.

The display device 1 having arrangements as described heretofore applies voltage that varies according to an image signal (image data) to each pixel electrode associated with each of the pixels arrayed in a matrix pattern to thereby vary optical characteristics of each pixel (liquid crystal layer 3c) and to display an image. The display device 1, in particular, employs integral imaging by which a plurality of parallax images (two-dimensional images) that are viewed subtly differently according a viewing angle are displayed and a stereoscopic view image is thereby formed. The stereoscopic view image is natural and easy to view, and gives viewers less stress. In addition, the range over which such a stereoscopic view image can be viewed is continuous.

A method for manufacturing the display device 1 will be described below. The lens panel 4 is positioned relative to, and placed on, the display panel 3. With the lens panel 4 pressed against the display panel 3, the internal space N is depressurized via the opening 5a. At this time, because of the spacer 6 interposing between the display panel 3 and the lens panel 4, a gap is properly maintained between the display panel 3 and the lens panel 4. After the internal space N has been depressurized, the opening 5a is sealed by the sealing material 7.

As described heretofore, the spacer 6 is disposed between the display panel 3 and the lens panel 4. The gap can be thereby properly maintained between the display panel 3 and the lens panel 4. This allows the display device 1 to display a good image.

In the first embodiment, the spacer 6 is columnar in shape. As compared with an arrangement in which a spacer is, for example, formed into a wall, light emitted from the display panel 3 reaches the lens panel 4 even more favorably.

Additionally, in the first embodiment, the spacer 6 comprises a plurality of spacers 6 disposed in a matrix pattern. The gap between the display panel 3 and the lens panel 4 can therefore be made as uniform as possible at different positions.

Additionally, in the first embodiment, the first part of the multiple spacers 6 faces the image display area 3f of the display panel 3, so that a gap can be properly maintained between the image display area 3f and the lens panel 4.

Additionally, in the first embodiment, the second part of the spacers 6 is disposed at the connector 5, so that a gap can be properly maintained between the display panel 3 and the lens panel 4 at the connector 5.

Additionally, in the first embodiment, the spacer 6 is transparent, so that light emitted from the display panel 3 reaches the lens panel 4 properly.

In a structure in which the display panel 3 and the lens panel 4 are directly affixed to each other, if the polarizing plate 3e of the display panel 3 has a smooth surface, uneven contact occurs between the polarizing plate 3e and the lens panel 4, aggravating display performance. The uneven contact can be avoided to some extent by having irregularities on the surface of the polarizing plate 3e; however, having irregularities on the surface of the polarizing plate 3e can at times result in aggravated crosstalk of the stereoscopic view image. In contrast, in the first embodiment, the spacer 6 disposed between the display panel 3 and the lens panel 4 improves display performance.

The first embodiment has been described for the columnar spacer 6 incorporated as a spacer. The spacer may alternatively be, for example, a wall-shaped element. The wall-shaped spacer may, for example, be in a matrix or honeycomb pattern. Preferably, however, the wall-shaped spacer is transparent.

The liquid crystal display panel is not the only possible type to be used for the display panel. Examples of the types of display panels include, but not limited to, a plasma display panel that illuminates phosphors using ultraviolet rays from plasma discharge, a field emission display panel that illuminates phosphors using an electron beam of a field emission electron emitter, and an electron emission display panel that illuminates phosphors using an electron beam of a surface-conduction electron emitter.

A liquid crystal gradient index (GRIN) lens capable of electrically switching lens functions required for display may be used for the lens panel 4. The liquid crystal GRIN lens creates a refractive-index distribution with the electrode using a flat liquid crystal layer.

Additionally, the connector 5 may be formed annularly, instead of having the opening 5a therein, to thereby eliminate the sealing material 7. In this case, the display panel 3 and the lens panel 4 are affixed together in, as an example, vacuum.

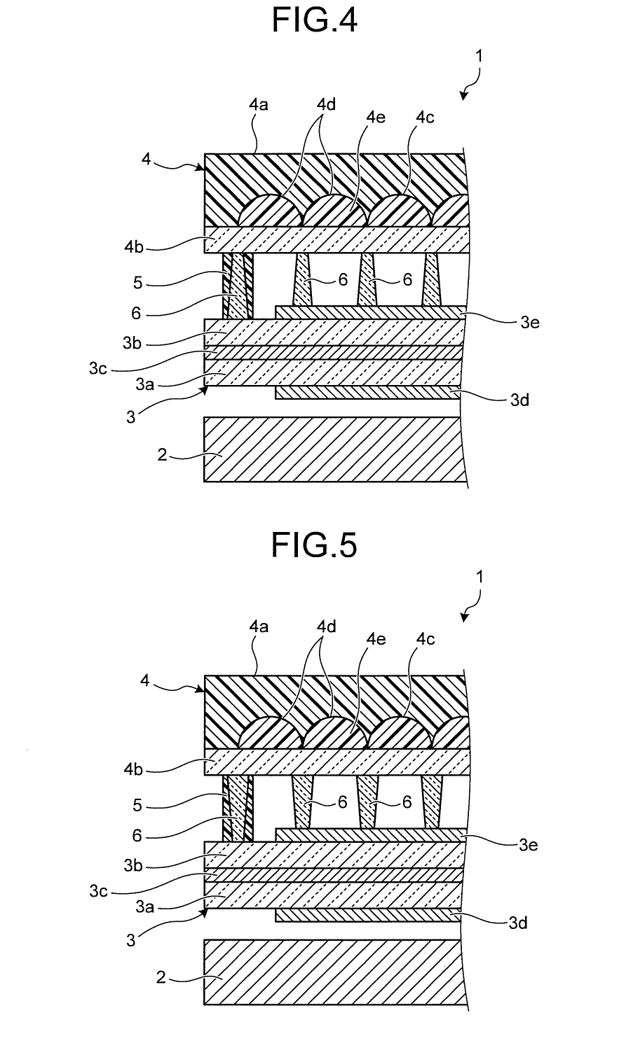

Modified examples of the first embodiment will be described below. The spacer 6 according to a first modified example illustrated in FIG. 4 is formed into a taper having diameters decreasing from the display panel 3 toward the lens panel 4. The spacer 6 according to a second modified example illustrated in FIG. 5 is formed into a taper having diameters decreasing from the lens panel 4 toward the display panel 3.

### Second Embodiment

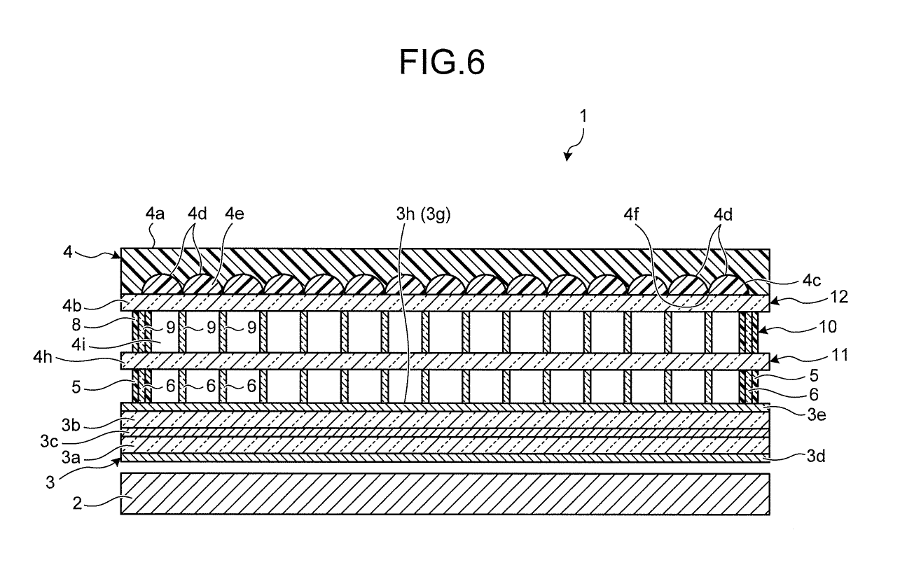

As illustrated in FIG. 6, a second embodiment differs from the first embodiment in that the lens panel 4 comprises a liquid crystal module 10. The liquid crystal module 10 is to switch between a planar view image and a stereoscopic view image. The liquid crystal module 10 is an exemplary switch cell.

In the lens panel 4, the liquid crystal module 10 is disposed on an image display side of the display panel 3 and the lens substrate 4a is disposed on a side of the liquid crystal module 10 opposite to a side thereof adjacent to the display panel 3. The liquid crystal module 10 faces the first surface 3g of the display panel 3. The first surface 3g of the second embodiment is formed by the front surface (a first surface) 3h of the polarizing plate 3e.

The liquid crystal module 10 is, as an example, a TN liquid crystal panel. The liquid crystal module 10 comprises a back substrate 4h, the substrate 4b as a front substrate, a spacer 9, a liquid crystal layer 4i, and a connector 8. The back substrate 4h is an exemplary first substrate. The substrate 4b is an exemplary second substrate. The spacer 9 is an exemplary second spacer.

The back substrate 4h is disposed on the image display side of the display panel 3. The back substrate 4h faces the first surface 3g of the display panel 3. The substrate 4b is disposed on the side opposite to the side of the back substrate 4h adjacent to the display panel 3 and spaced away from the back substrate 4h. The liquid crystal layer 4i is disposed between the back substrate 4h and the substrate 4b.

The connector 8 is disposed between a peripheral edge portion of the back substrate 4h and the peripheral edge portion of the substrate 4b, connecting the peripheral edge portion of the back substrate 4h and the substrate 4b through, for example, bonding. The connector 8 is formed into, for example, a substantially rectangular frame shape. A light-curing resin, for example, is used for the connector 5.

The spacer 9 comprises a plurality of spacers 9 disposed between the back substrate 4h and the substrate 4b. The spacer 9 is shaped and arrayed in the same manner as a spacer 6. In the second embodiment, the spacer 6 is disposed on the back substrate 4h, while the spacer 9 is disposed on the substrate 4b.

In the second embodiment, the back substrate 4h and the spacer 6 are integrally formed to constitute a first member 11 and the substrate 4b and the spacer 9 are integrally formed to constitute a second member 12. The first member 11 and the second member 12 have an identical shape. The spacers 6, 9 are disposed through, as an example, photolithography.

The liquid crystal module 10 is capable of switching between a stereoscopic view image display mode and a planar view image display mode. Specifically, in the stereoscopic view image display mode, a polarizing direction of light (image) emitted from the display panel 3 is not rotated and, in the planar view image display mode, the polarizing direction of the light emitted from the display panel 3 is rotated through 90 degrees.

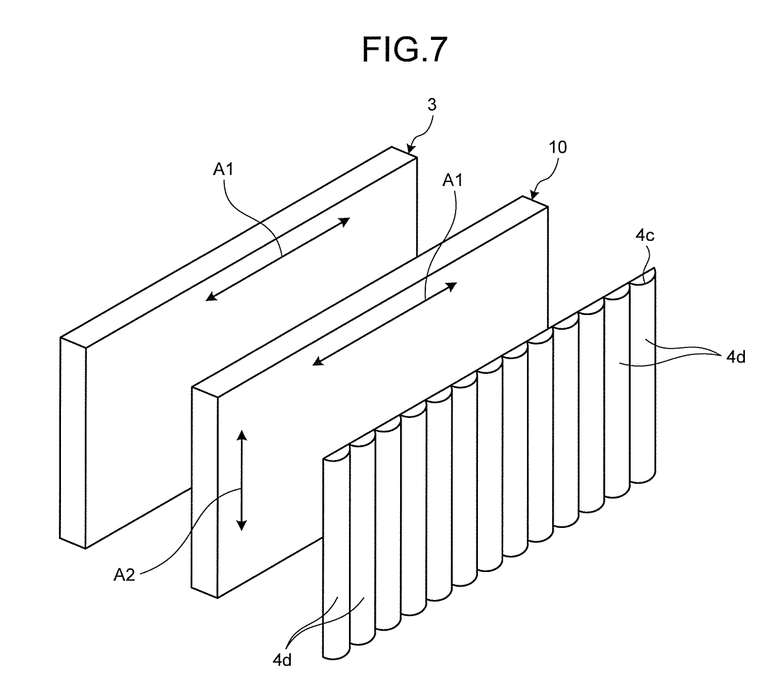

As illustrated in FIG. 7, in the display panel 3, light is polarized in a direction of 90 degrees rotated relative to an axial direction of cylindrical lenses 4d (the direction of an arrow A1 in FIG. 7) before being emitted. Then, in the stereoscopic view image display mode, the polarizing direction of light in the liquid crystal module 10 is adjusted to 90 degrees rotated relative to the axial direction of the cylindrical lenses 4d (the direction of the arrow A1 in FIG. 7). As a result, a lens effect of the lenticular lens 4c causes the light from each pixel of the display panel 3 to form and output a stereoscopic view image. In the planar view image display mode, on the other hand, the polarizing direction of the light in the liquid crystal module 10 is adjusted to a direction that coincides with the axial direction of the cylindrical lenses 4d (the direction of an arrow A2 in FIG. 7). This results in the light from each pixel of the display panel 3 being output as a planar view image without being affected by the lens effect of the lenticular lens 4c.

As described heretofore, also in the second embodiment, the spacer 6 is disposed between the display panel 3 and the lens panel 4 as in the first embodiment. A gap between the display panel 3 and the lens panel 4 can thereby be properly maintained, so that the display device 1 can display a good image.

In the second embodiment, the back substrate 4h and the spacer 6 are integrally formed to constitute the first member 11 and the substrate 4b and the spacer 9 are integrally formed to constitute the second member 12. This prevents the number of parts used from increasing.

The first member 11 and the second member 12 have an identical shape. The first member 11 and the second member 12 can therefore be formed of a single part, which prevents the number of part varieties from increasing.

### Third Embodiment

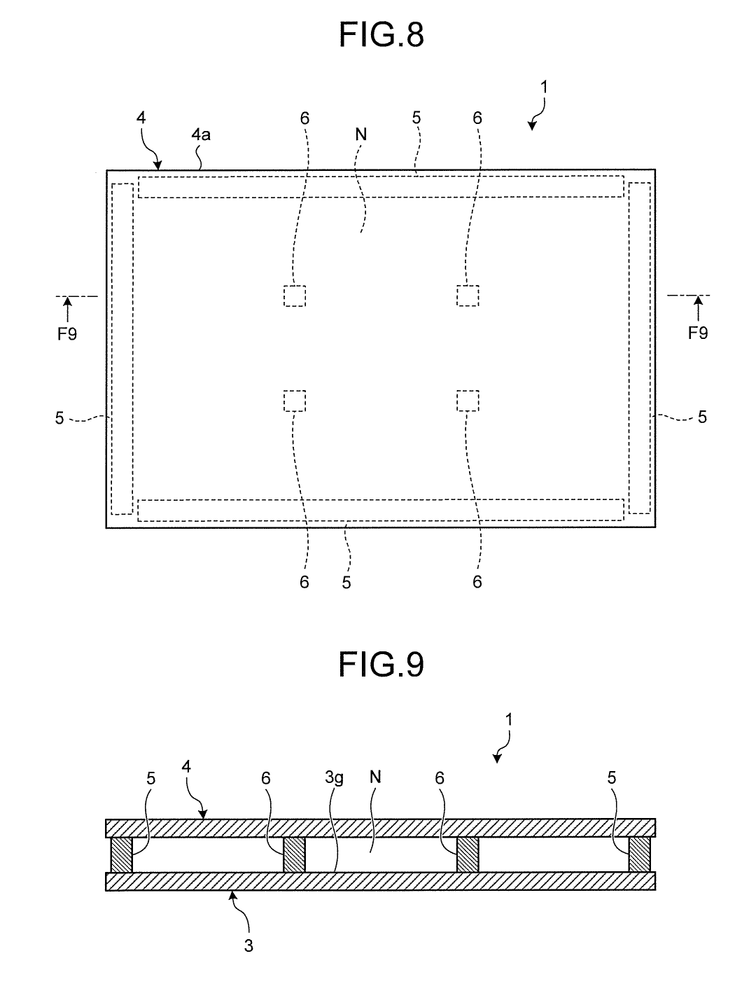

As illustrated in FIGS. 8 and 9, a third embodiment differs from the first embodiment in the connector 5 and the spacer 6. It is noted that FIGS. 8 and 9 illustrate relevant sections schematically.

The connector 5 in the third embodiment is disposed, as in the first embodiment, between the peripheral edge portion of the display panel 3 and the peripheral edge portion of the lens panel 4, connecting the display panel 3 and the lens panel 4 through, for example, bonding. The connector 5 comprises four connectors 5, each being disposed at each of four sides of the display panel 3. In the third embodiment, the internal space N is not depressurized. This eliminates the opening 5a and the sealing material 7 described with reference to the first embodiment.

The spacer 6 is, as an example, columnar in shape. The spacer 6 is, as an example, a quadrangular prism. The spacer 6 faces the image display area 3f of the display panel 3. The spacer 6 is formed of an adhesive, connecting the display panel 3 and the lens panel 4 together.

As described above, also in the third embodiment, the spacer 6 is disposed between the display panel 3 and the lens panel 4 as in the first embodiment. A gap between the display panel 3 and the lens panel 4 can thereby be properly maintained, so that a display device 1 can display a good image.

### Fourth Embodiment

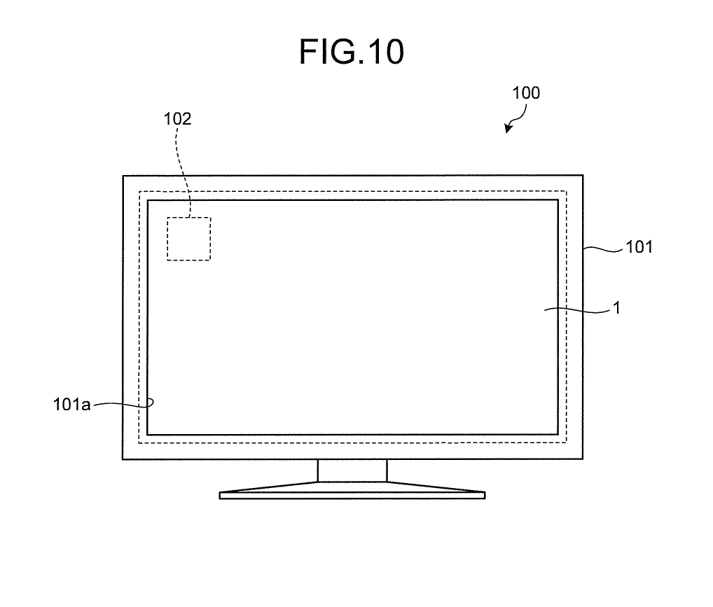

Referring to FIG. 10, a television receiver (electronic device) 100 of a fourth embodiment comprises a cabinet 101 and the display device 1 accommodated in the cabinet 101. The display device 1 is exposed from an opening 101a in the cabinet 101. A circuit substrate (controller) 102 is disposed on the back side of the display device 1 inside the cabinet 101. The circuit substrate 102 comprises, for example, a central processing unit (CPU), an image signal processing circuit, a tuner, a storage (e.g., read only memory (ROM) and random access memory (RAM)), and an audio signal processing circuit. The circuit substrate 102 controls, for example, output of an image (e.g., a moving or still image) at the display device 1 and output of voice at a speaker (not illustrated).

The television receiver 100 having arrangements as described above allows the display device 1 to display a good image in the same manner as in the first embodiment described earlier.

As described heretofore, in the first to fourth embodiments, the display device 1 can display a good image.

Moreover, the various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A display device comprising:
an image display module having a first surface;
a lens module configured to face the first surface and to be connected to the image display module by a connector with a gap from the image display module; and
a first spacer configured to be disposed between the image display module and the lens module.

2. The display device of claim 1, wherein the first spacer is configured to be columnar in shape.

3. The display device of claim 1, wherein the first spacer comprises a plurality of the first spacers configured to be disposed in a matrix pattern.

4. The display device of claim 1, wherein
the display device comprises the first spacer configured to face an image display area in the image display module; and
the connector is configured to be disposed outside the image display area.

5. The display device of claim 1, wherein the display device comprises the first spacer configured to be disposed at the connector.

6. The display device of claim 1, wherein the first spacer is configured to be transparent.

7. The display device of claim 1, wherein
the lens module comprises a plurality of lenses configured to be disposed in parallel with each other, and
the display device comprises the first spacer configured to be disposed at boundary between the lenses configured to be adjacent to each other, overlapping in a direction in which the image display module and the lens module overlap each other.

8. The display device of claim 1, wherein
the lens module comprises a liquid crystal module configured to face the first surface and a lens substrate configured to be disposed on a side opposite a side of the image display module of the liquid crystal module;
the liquid crystal module comprises: a first substrate configured to face the first surface, a second substrate configured to be disposed on a side opposite a side of the image display module of the first substrate and to be spaced away from the first substrate, a second spacer configured to be disposed between the first substrate and the second substrate, and a liquid crystal layer configured to be disposed between the first substrate and the second substrate;
the first substrate and the first spacer are configured to be integrally formed to constitute a first member; and
the second substrate and the second spacer are configured to be integrally formed to constitute a second member.

9. The display device of claim 8, wherein the first member and the second member have an identical shape.

10. A television receiver comprising:
a display device, wherein
the display device comprising:
an image display module having a first surface;
a lens module configured to face the first surface and to be connected to the image display module by a connector with a gap from the image display module; and
a first spacer configured to be disposed between the image display module and the lens module.
